(19) United States
(12) Patent Application Publication
(10) Pub. No.: US 2023/0217894 A1
(43) Pub. Date: Jul. 13, 2023

(54) HORSE INFORMATION AND IDENTIFICATION SYSTEM

(71) Applicant: Trilanco, LLC, Gardner, KS (US)

(72) Inventors: Nancy J. Thomas, Drake, CO (US); Alan D. Thomas, Drake, CO (US)

(21) Appl. No.: 17/575,268

(22) Filed: Jan. 13, 2022

(51) Int. Cl. A01K 11/00; B68C 1/20; G09F 3/02; G09F 3/14

(52) U.S. Cl. CPC A01K 11/00; B68C 1/20; G09F 3/02; G09F 3/14; G09F 2003/0208; G09F 2003/0257

(57) ABSTRACT

Systems and devices in accordance with embodiments provide one or more tags for use with horses and/or riders, to provide readily-visible and accessible horse or rider information. For example, a horse tag is configured to be semi-permanently affixed to a portion of a mane and includes one or more strips of fluorescent material and/or a reflective, recognizable symbol indicating information about the horse is available.

### BACKGROUND

There are needs for improved systems and devices for the identification and treatment of horses and/or riders. Needs exist for effective identification mechanisms for horses, including longer-term solutions that can be affixed to a horse, without unwanted side effects. For example, there is a need to be able to locate one or more horses, including in unusual circumstances such as emergency situations (e.g., during a fire), at temporary locations such as shelters or horse shows, and/or at other times when a rider or owner may be separated from a horse.

Horses as described herein can include members of the Equidae family. As used herein, a rider is a human person or entity associated with a horse, such as a trainer, owner, care-taker, or other individual with a connection to a horse. A rider can be separated from a horse or horses due to certain circumstances, which can lead third-party individuals or organizations to look for or find the horse(s). In some cases, a rider is seeking to find or confirm the identity of one or more horses, and/or responders such as emergency professionals or volunteers may need to locate or treat one or more horses. As one example, an accident could occur during a horse ride that leaves a rider incapacitated in some respect, or a rider could have a health problem or other issue during a horse ride, and become separated from a horse. Or an accident due to an oversight, such as a horse not being secured or a failure of a fence or other system, can lead to a horse being in an unidentified or unfamiliar location, with no readily-available information that is visible to individuals.

In other examples, a severe weather event such as a tornado or hurricane or storm, could lead to horses becoming unrestrained or uncontained, such that the horses need to be found or identified, and possibly treated for one or more conditions, or have their identities confirmed, in order to successfully care for the horses and/or enable contact with one or more riders. Horses may travel, with or without their respective rider(s), due to relocations, horse shows including competitions, or for other commercial or personal reasons. In the context of transporting horses, whether planned or in an emergency situation, horses may be grouped together or handled in various manners to provide transport and lodging for the horses. This can lead to issues with identifying and treating horses quickly, in an effective manner, for example when certain information, such as medical background or contact information, is needed in near real-time and is needed to be visible to third-party individuals. In one example, a set of more than one horse is kept overnight in a certain location, as a group, and one of the horses needs immediate medical treatment (for example, veterinary care), and the other horses need to have their riders notified of their potential exposure to the medical issue of the first horse.

In some cases, horses may be lodged or cared for without a rider nearby, for example at a show or other event. Additionally, at a show or other event, or during a situation such as an emergency, multiple horses with inaccessible or unknown riders may need treatment, such as to be moved or medically treated, but limited veterinary resources may exist to identify each horses' rider and/or veterinary contact information. For example, during an evacuation where responders are trying locate one or more horses, each horse may also need preliminary screening or emergency care, or to be counted or identified, and in some cases the available individuals may not be prepared or qualified to identify the horses or their medical conditions. It may be the case that certain riders, such as owners of horses, are forced to reach out to individuals on the scene to try to determine the location and/or condition of their associated horses, and the individuals on the scene may not visually recognize horse breeds or conditions, or may not be able to find identifying information for the horses.

Certain conditions such as disasters can make it even more difficult to identify or locate horses, and no long-term solution exists to aid the location and treatment of horses in such conditions. As one example, during a fire, the fire or smoke can make it difficult to determine where horses are housed or to find relevant information about each horse. Conditions such as fire and flood can cause electricity issues, making it even more difficult to locate horses, for example using flashlights or other searching or emergency lights. During various temporary situations, such as evacuations or other emergencies, individuals may be in the presence of horses in nature, or at a designated location for animals, and the individuals may not be able to readily discern the identification of each horse or information about the horse. In some situations, a rider may be physically nearby or accessible, but it is not clear which rider is associated with which horse, particularly in a time frame for effective veterinary treatment.

There is also a need for efficient, visual identification of available information about a horse for purposes of connecting with a rider, such as an owner, needed to transport or reunify with a horse, or to provide additional information; in some cases the information is needed for purposes of treatment at a scene or of an immediate nature. In some cases, a horse or horses may be stolen or lost and require reunification and/or temporary care. Horses can have conditions that affect or dictate how each horse should be treated in a certain situation, for example if a horse has known issues relating to its hooves or joints that may affect transport, or health issues that may require additional treatment relating to breathing during or after smoke exposure, or known dietary issues, any or all of which may need to be communicated readily. Existing approaches fail to attract sufficient attention or be noticed in a manner that facilitates rapid and informed treatment of horses and/or riders. For example, one conventional approach includes painting or otherwise marking on hooves or horses, which is not easily identifiable, particularly from a distance.

A need exists for longer-term solutions, which will stay affixed or in place with respect to a horse, without aggravating or affecting the horse or rider, while still gaining the attention of others, such as emergency workers or veterinary professionals, including in limited visibility such as dark or smoky conditions, or in a crowded or chaotic situation. Additionally, such emergency workers or other professionals often perform with limited time frames and/or with various language barriers, due to conditions or limited resources, so they cannot dedicate the resources needed to use overly-complex or technical chip-based systems prior to accessing any contact information, for example. A solution is needed in an ideal and/or convenient size, and in some cases with markings, to be visible and effective while also allowing long-term placement and fixation that will not interfere with other activities, such as riding or showing a horse, but will be readily seen or understood prior to treatment of a horse. Current systems such as athletic wrist bands for human workouts or temporary tags for horses, fail to meet these needs and do not provide effective solutions for identifying horses, riders, and/or information about the horses or riders.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, systems and devices for providing tag systems for horses and/or riders. For example, embodiments include an identification system with a tag in a substantially rectangular shape and a strip of fluorescent material on one or more edges of the tag, and a display of information associated with a horse on the tag. In some cases, the strip is an additional layer of material applied to one or more edges, for example with portions of the additional layer of material on the front and back sides of the tag. The strip can include a reflective material, such as fluorescent or metallic material, and/or stripes of reflective material. In embodiments, a strap is removably connected to the tag and the strap is also configured to be removably connected to a first element, such as a mane or saddle, or an article of clothing. In some cases, a first portion of the strap is configured to at least partially overlap a portion the element, such as mane, for example configured to encompass a portion of an interwoven or braided aspect of a mane or tail. The tag can include a reflective graphic, to aid its visibility and to communicate the type of information contained in the tag, for example in an emergency situation.

Embodiments include a tag system for use with a horse, including a tag with an insert and a strap configured to form a closed loop, along with a medically-related indication on the side of the tag, which can be reflective. The tag can include one or more edges with one or more fluorescent strips applied to each of the one or more edges. The insert may convey information associated with a horse or a rider, or both, for example. The strap may be configured to affix the tag to a saddle or a mane. A strap may be configured to affix the tag to a mane by forming a loop around a portion of the mane when the portion of the mane is woven. In some cases, a tag system includes a tag device containing a display of contact information and a closed-loop strap, where a face of the tag device includes a reflective material. The tag system can be configured to be semi-permanently secured to a horse, in embodiments. In some cases, the contact information is veterinary contact information and/or other medical or contact or owner information.

### BRIEF DESCRIPTION OF THE DRAWINGS

Embodiments are described in detail below with reference to the attached drawing figures, wherein:

FIG. 1A illustrates an exemplary tag suitable to implement embodiments of the present invention;

FIG. 1B illustrates the reverse or back side of an exemplary tag suitable to implement embodiments of the present invention;

FIG. 2A illustrates an exemplary display suitable to implement embodiments of the present invention;

FIG. 2B illustrates an exemplary display suitable to implement embodiments of the present invention;

FIG. 3A illustrates an exemplary tag system, suitable to implement embodiments of the present invention, affixed to a saddle;

FIG. 3B illustrates an exemplary tag system, suitable to implement embodiments of the present invention, affixed to an individual person;

FIG. 3C illustrates an exemplary tag system, suitable to implement embodiments of the present invention, affixed to a mane; and

FIG. 3D illustrates an exemplary tag system, suitable to implement embodiments of the present invention, affixed to an item of clothing.

### DETAILED DESCRIPTION

The subject matter of the present invention is described with specificity herein to meet statutory requirements. However, the description itself is not intended to limit the scope of this patent. Rather, the inventor(s) have contemplated that the claimed subject matter might also be embodied in other ways, to include different aspects or combinations of aspects similar to the ones described in this document, in conjunction with other present or future technologies. Embodiments of the invention described herein provide one or more tags, such a tag 100, described below, which enable rapid identification of horse or rider information, leading to more timely and effective treatment of horses, for example.

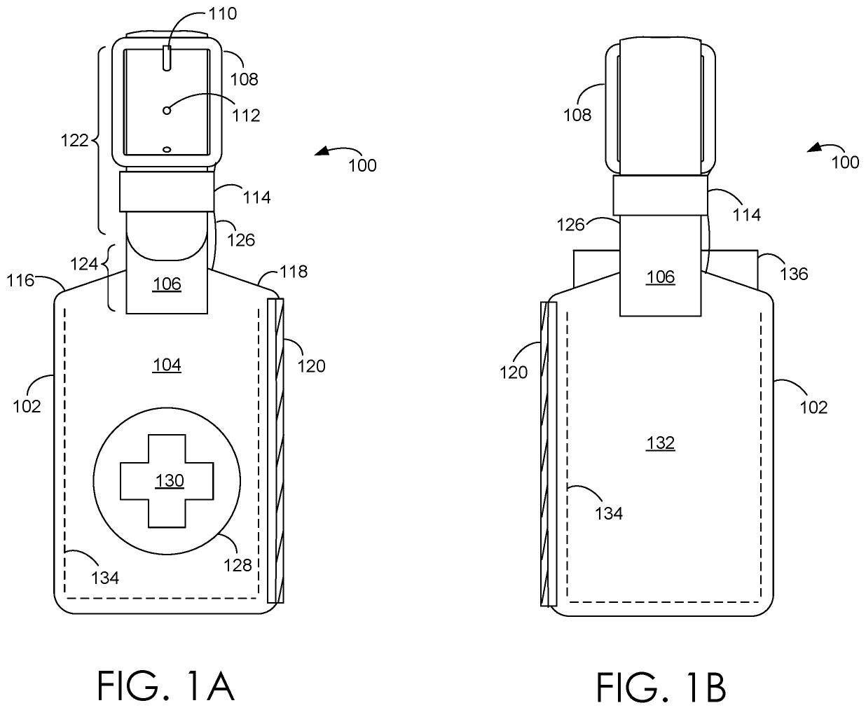

Turning to FIG. 1A, an exemplary tag 100 is shown in accordance with an embodiment of the present invention. This illustrative tag 100 includes a main tag portion 102, one side of which (the side of main tag portion 102 facing the viewer) comprises tag front face 104. Extending from the main tag portion 102 is a strap 106, as shown in FIG. 1A. Strap 106 can be connected to main tag portion 102 by stitching, adhesive, or another form of affixing strap 106 to main tag portion, such as having strap 106 inserted or looped through an opening in main tag portion 102. In some cases, main tag portion 102 and strap 106 are integrally formed as one piece, in which case strap 106 and main tag portion 102 could be made of the same material or components, or they could be manufactured or three-dimensionally printed to include multiple materials within a one-piece formation.

Strap 106 extends upward from main tag portion 102, for example from a midpoint of the top side of main tag portion 102, and strap 106 has an extended rectangular shape with a width approximately one-third of the width of main tag portion 106, for example. Strap 106 may have a curved or rounded distal end, at the point furthest from main tag portion 102, for example the two distal corners of the extended rectangular shape of strap 106 can be omitted or smoothed, as illustrated in FIG. 1A, in order to cause less abrasion or annoyance to a horse or rider.

Strap 106 may include and interact with a buckle portion 108, shown in FIG. 1A as including a rectangular frame that is wider than and receives strap 106. Buckle portion 108 can include a rectangular frame, with or without rounded corners, or in some cases buckle portion 108 can be an oval or other shape, or another style of buckle, such as a buckle using a clip or compression to secure strap 106. For example, strap 106 can be inserted into buckle portion 108, and strap 106 can be pulled back through buckle portion 108, such that strap 106 is below buckle portion 108 (while also above a piece, not shown, of buckle or other material).

In the example shown in FIG. 1A, a member 110 extends through an opening, such as one of openings 112, to secure strap 106 with buckle portion 108. Any number of openings 112 can be provided, for example three are shown in FIG. 1A, with member 110 in FIG. 1A inserted into the lowest, or tightest, of the openings 112 in this example, which means strap 106 was pulled further through buckle portion 108 than it would have been if a higher or looser of the openings 112 had been used, in this example. In embodiments, the direction of strap 106 with respect to buckle portion 108 can be reversed, with a distal end of a strap 106 extending upwardly (instead of downwardly as shown) through buckle portion 108.

A keeper 114 can be included to receive or secure an end of strap 106. In embodiments, keeper 114 is part of, or affixed to, an under layer of strap 106 (discussed below), similar to a buckle portion attached to a under layer or overlapped portion of strap 106. Keeper 114 can be various sizes and can be placed in various positions with respect to a buckle portion 108 or other fastening mechanism. Keeper 114 is optional, but in some cases the use of keeper 114 a short or moderate distance from a buckle portion 108 can keep strap 106 from becoming loose or unbuckled or other undone, and keeper 114 can minimize irritation or distraction due to the end of strap 106, beyond where strap 106 is buckled or hooked. Keeper 114 can also hold portions of the strap 106 proximate one another to prevent an open loop from forming, which could catch, snag, couple, temporarily affix, and the like on an object(s) and cause distress and/or danger to a horse or rider. In some cases, a keeper 114 can be comprised of leather, or a keeper 114 may be made of an elastic material.

In the example in FIG. 1A, main tag portion 102 is substantially rectangular in shape and can include rounded or somewhat smoothed corners, in some cases, while maintaining an overall rectangular configuration. In some cases, another shape besides rectangular could be used, such as an oval or a substantially square shape, while maintaining the general overall dimensions and/or features, such as strip 120, for example, discussed below, to provide a readily-visible tag 100 and to effectively convey information about a horse and/or rider.

Embodiments of the present invention can include a main tag portion 102 with dimensions of approximately 2 and ¾ inches (approximately 7.25 mm) to 2 and ⅛ inches wide, not including rounded corner portions, and approximately 4 and ¼ inches in length, which can be readily seen or recognized and convey critical information (i.e., be large enough) without interfering or adversely affecting a horse or rider (i.e., compact enough). A tag 100 can be lightweight, for example under one ounce (e.g., 0.5 to 0.6 ounces), which may further reduce any interaction or irritation from a tag 100. Additionally, main tag portion 102 and/or strap 106 can be comprised of materials with various levels of rigidity. In an embodiment, a main tag portion 102 is more rigid than a strap 106, such that strap 106 has more flexibility or potential to curve or adapt in shape, while main tag portion 102 remains relatively flat, in order to display information (e.g., display 210) and/or to present a graphic area, as discussed below with respect to FIG. 1B. A strap 106 is approximately 0.5 inches wide, with a length of approximately 6 inches when unbuckled and flattened, in an embodiment. In some cases, strap 106 has a different width and/or length.

As one example, a plastic material could be used to construct or reinforce tag 100, in combination with a leather or fabric strap 106. In embodiments, tag 100 and strap 106 are comprised of a material, such as leather or suede, while display 200 or second display 210, discussed below, is comprised of a plastic or coated material and inserted into tag 100. A rider tag 100 can be shorter in length, for example under 4 inches, to be less distracting or burdensome to a rider while still attracting the attention of third parties.

An upper portion of main tag portion 102 can include one side with two sloped edge portions 116, 118. The sloped portions 116, 118 can provide material for reinforcement or support adjacent to where a strap 106 is inserted through or attached to a main tag portion 102, while keeping a substantially rectangular shape available for use to display information or other content. For example, strap 106 can extend from both faces of a main tag portion 102 because of an opening allowing the strap 106 to pass through the main tag portion 102, for example near an edge of main tag portion 102 with two sloped portion, or strap 106 can be sewn or otherwise attached to either side of main tag portion 102, for example near an edge, as shown in FIGS. 1A and 1B.

Continuing with FIG. 1A, tag 100 includes one or more strips, such as strip 120, at one or more edges of tag 100, for example. In the embodiment in FIG. 1A, strip 120 has been applied or used along the right side of tag 100. Strip 120 can be reflective, bright, neon, or be comprised of other bright or metallic material, or strip 120 can include one or more glow-in-dark, gel glow, or LED aspects, in order to provide additional visibility and/or to communicate to a third party that tag 100 contains emergency or identification information. In some cases, strip 120 can include fluorescent binding along an outside edge (for example at a seam) of each side of tag 100, which will remain visible in dark or smoky conditions, in some cases reflecting or illuminating when an emergency responder or other personnel flashes a flashlight at a horse, for example. In some cases strip 120 is a piece of fluorescent and fluorescent-striped material. Strip 120 can be approximately 0.5 inches wide, in some embodiments, although other widths can be used, and the width of a strip 120 may be decreased from the perspective of a viewer if one or more strips, such as strip 120, have been applied over an edge such that strip 120 is visible from a front view of tag 100 and a back or side view of tag 100, as well.

As stated, in some cases, strap 106 is inserted through main tag portion 102 such that it extends from tag 100 from both the tag front face 104 (extending upwards until buckle portion 108) and from the tag back face 132 (extending upwards until a distal end of the strap 106, which can be inserted into buckle portion 108 and overlap with the portion of strap 106 extending from tag front face 104, creating overlap portion 122). When buckled or otherwise secured to itself, strap 106 creates a closed or continuous loop, which extends from (or through) main tag portion 102. As shown in FIG. 1A, for example, when strap 106 is closed or in a loop position, using buckle portion 108, strap 106 includes overlap portion 122, and a non-overlap portion 124.

FIG. 1B shows a back or reverse view of an exemplary tag 100 in accordance with embodiments, for example the backside of tag 100 in FIG. 1A. In some cases, strap 106 is attached, at one end, to a piece (not shown) of buckle portion 108, so that strap 106 extends from one end of strap 106, at buckle portion 108, to a distal end of strap 106, which is shown as dividing the overlap portion 122 from the non-overlap portion 124 of strap 106 in FIG. 1A. When strap 106 is inserted through buckle portion 108, pulling strap 106 further through buckle portion 108 makes the overall loop comprised of strap 106 shorter or tighter, for example. FIG. 1A partially shows a back strap portion 126 (and FIG. 1B, showing the back or reverse of tag 100, illustrates a back strap portion 126 extending upwardly from main tag portion 102).

When strap 106 is buckled or closed into a loop, for example as shown in the embodiment in FIGS. 1A and 1B, the overlap portion 122 and the non-overlap portion 124 of strap 106 are substantially aligned with the back strap portion 126, with the loop of strap 106 essentially creating three layers of strap 106 where the overlap portion 122 and back strap portion 126 are overlapping or substantially aligned, and with two layers of strap where non-overlap portion 124 and back strap portion 126 are viewed on top of each other, as shown in FIGS. 1A and 1B. As shown in FIGS. 1A and 1B, keeper 114 can surround or encompass one or more layers of strap 106, for example three layers (overlapping portion 122 and back strap portion 126), as shown. Alternatively, keeper 114 can be secured around two layers of strap 106 (for example, around non-overlapping portion 124 and back strap portion 126).

Continuing with FIG. 1A, a front face 104 of tag 100 can include one or more graphic areas, such as graphic area 128. A graphic area 128 can be a substantially planar and/or smooth surface area of front face 104, which can be provided by a relatively rigid material, in some cases to enable better reflection or other return of wavelengths or signals. For example, a plastic or other synthetic material can be used to provide waterproof properties and/or to provide a substantially flat or smooth graphic area, which will improve a response to a flashlight or other detection system. Graphic area 128 is optional, or can comprise a plain area or front face 104 that is reflective or otherwise coated or treated, or made of a material, to catch attention, including in dark or smoky conditions, for example, or under time constraints. In embodiments, graphic area 128 can include one or more symbols, such as symbol 130. In the example shown in FIG. 1A, a cross symbol is used, for instance surrounded by a circular graphic area 128 of reflective material, because a cross symbol (for example, a red cross) is widely understood to communicate emergency and/or medical information, in any language. A reflective or metallic symbol can include a known symbol or a cut-out creating the symbol, for example applied in reflective paint or printed with metallic elements. In embodiments, other icons such as “911” can be used, and such symbols could be applied using an adhesive or paint, for example.

As shown in FIGS. 1A and 1B, a tag 100 can include a front face 104 and a back face 132, where the front face 104 and the back face 132 are each panels. The two panels are attached or connected along one or more sides of tag 100 to create a pocket, in embodiments. For example, stitching 134 can be used along one or more edges or sides of tag 100. For example, stitching 134 may extend along the lower and side edges, while the strap 106 secures the display 200 within the tag 100 along the top edge. In some embodiments, front face 104 and back face 132 each comprise a leather panel, which are secured together along one, two, or three edges, for example by stitching 134 near three edges of tag 100. A strap 106 may secure a display 200 on one side, such that stitching is not needed or optional along an edge where a strap 106 is used. Other manners of connecting or securing two panels can be implemented, in some cases, to secure a display (e.g., display 200) inside of a tag 100. A display 200 can slide into or out of tag 100, for example. In some cases, a display such as display 200 can be inside of a plastic sleeve 136, which can protect a display from damage or wear. A plastic sleeve 136 can remain inside tag 100 while a display 200 is removed, or a plastic sleeve 136 may also be removable, for example to protect a display 200 when removed from a tag 100, as well. In some cases, a plastic sleeve 136 provides a water-proof barrier around a display, such as display 200.

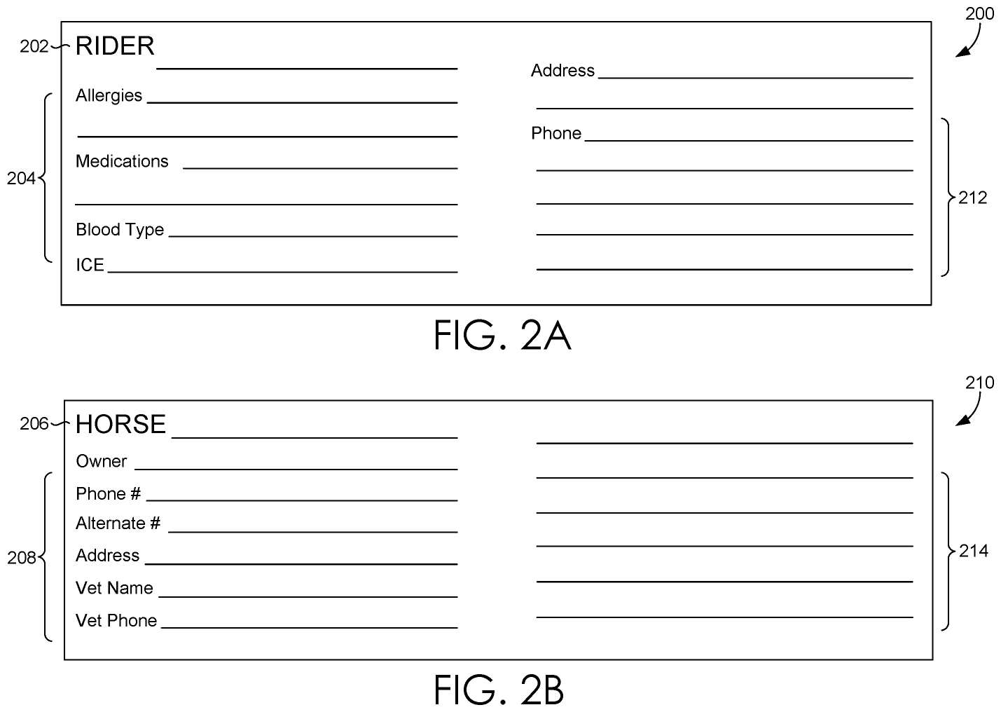

FIG. 2A illustrates one example of a display 200 in accordance with an embodiment of the present invention. A display such as display 200 can be shown on the reverse or back face of a tag 100, for example back tag face 132, or display 200 can be viewed by unfolding or otherwise opening display 200, such as by sliding out or revealing display 200 from an inner portion of a tag 100. In some cases, tag 100 can unfold along one edge or side of tag 100 such that two portions of tag 100 are side-by-side, with a display, such as display 200, spanning both portions when viewing tag 100 in an opened formation. In other cases, only part of display 200 may be visible in an opened tag 100, until display 200 is removed and/or further expanded. Display 200 can be made of various materials, including plastic or other materials that are waterproof or protected, for long-term use including in the outdoors. A display such as display 200, or second display 210 discussed further below, can be printed or applied directly to a tag 100, for example using heat or an adhesive. In some cases, a tag 100 used by a horse includes display 200 as an insert in a tag 100, while a rider can use a tag 100 with display 210 inserted.

A display, e.g., display 200, can include information relating to a rider, a horse, or both. In the example in FIG. 2A, display 200 includes rider identification 202, which can include a rider's name or other identifying information, such as a registration number. Display 200 can also include rider information 204, which can include, for example, allergies associated with a rider and/or medications associated with a rider. In the example in FIG. 2A, rider information 204 also includes blood type information and emergency contact information, for example. Other information can be included as part of rider information, or certain exemplary information shown in FIG. 2A can be omitted, in some embodiments.

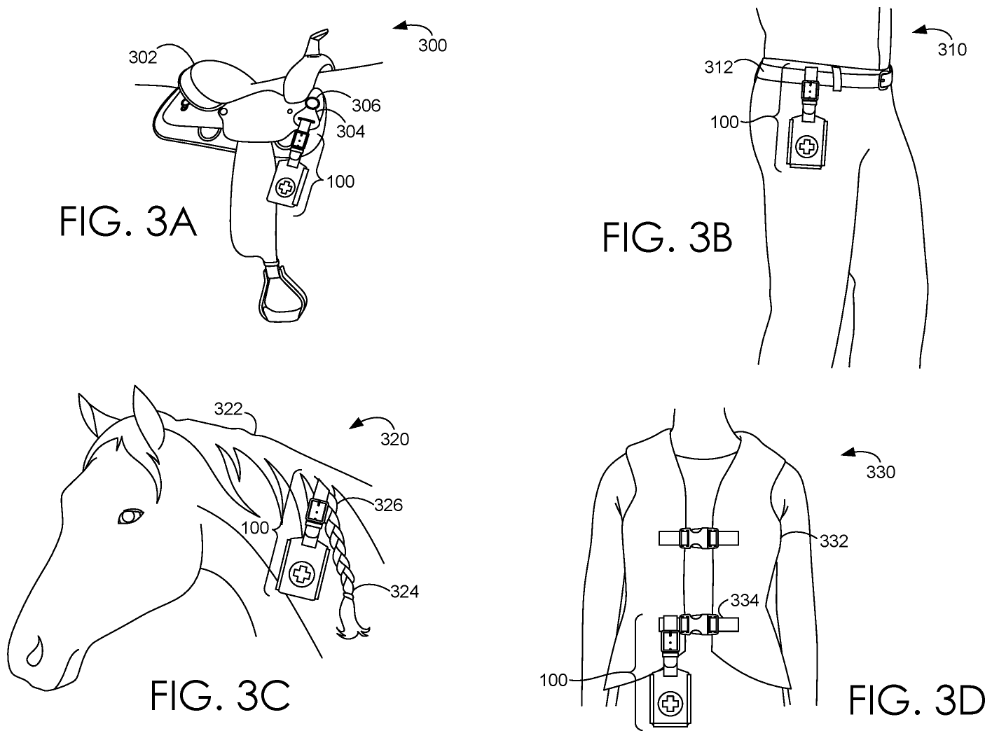

In some cases, as discussed in more detail with respect to FIG. 3B, a rider can wear a tag 100, which can enable immediate care for a rider found unresponsive or in need of treatment. For example, if a horse and rider are separated, rider information 204 may enable proper treatment of a rider and/or a determination that a particular rider is associated with a particular horse or organization. In some cases, display 200 of tag 100 can provide rider information 204 without requiring access to remotely-stored or protected medical records, which can be life-saving in the context of an equestrian accident requiring a blood transfusion, for example. In some cases, a tag 100 including a display 200 (or a second display 210, discussed below) is affixed to a horse (or to a rider and a horse), in which case the readily-visible tag 100 that may be accessed by an individual to determine rider information 204 for treatment of the rider and/or the horse. As one example, a rider and an associated horse on a trail could become separated during an event such as inclement weather or an earthquake. Certain rider information 204 including on tag 100 could alert the operation that the rider is likely in need of diabetes medication, for example. The operation may also be able to access an emergency contact from the rider information 204, and other useful information, prior to having access to the rider's medical records.

Turning to FIG. 2B, an exemplary second display 210 that can be used with embodiments of a tag 100 is shown. Although the display in FIG. 2B is referred to as a second display 210, in embodiments only second display 210 is used, for example where a tag 100 system is used with a horse or other member of the Equine family, but no tag 100 is used by a rider. In some cases, a horse may not have a rider in the vicinity, or the rider may not be identifiable or able to communicate, for example due to a language barrier. In embodiments, tag 100 is used with respect to, or on, a horse. A search or rescue operation may locate the horse and tag 100, because tag 100 is permanently affixed to a horse but also readily visible, due to its placement, size, and materials and/or graphics used, as described herein.

A second display 210, as illustrated in one example in FIG. 2B, can include horse identification 206, which may be a name, number, or other reference identifying a specific horse. Horse information 208 can include, for example, as shown, a horse owner, phone number, alternate number, address, veterinarian name, and veterinarian phone number. Horse information 208, for example owner data that indicates an individual or organization name, can enable rapid determination or confirmation of an individual or entity associated with a horse. Tag 100 can include display 210 and be affixed to an aspect of a horse, which provides efficient and reliable horse information 208 in a means that is readily visible and accessible to a third party, such as a veterinary professional or someone aiding the transport or supervision of the horse, or someone performing search or rescue activities.

In embodiments, tag 100 is worn by a horse and, even if a rider or other individual or entity cannot be identified immediately, horse information 208 can be used to still provide appropriate treatment. For example, an owner can be identified and/or contacted in order to receive permission for certain treatments, such as transport away from an emergency or a medical procedure, and/or a veterinarian may be identified for treatment in the absence of a rider or owner. In embodiments, a veterinarian may be able to provide medical information or advice without intervention by an owner or rider. Display 200 and/or second display 210 may include data arranged in other formats than the example shown in FIGS. 2A and 2B, which illustrate embodiments with rider identification 202 and rider information 204 on one display 200 and horse identification 206 and horse information 208 on a second display 210. In some cases, one or more tags, such as tag 100, in a system can include horse, rider, or horse and rider information. Both the horse information 208, and in some cases the rider information 204, can enable medical treatment and emergency care without fear of eliciting allergic reactions or other negative consequences, due to the information provided, and without requiring access of full or electronic medical records.

In some cases, horse information 208 includes contact information or other data for reaching out to an owner or professional regarding the horse, for example to treat the horse in a particular way (for example, feeding it certain food, transporting it in a particular way, or administering certain medications). In other cases, horse information 208 could include one or more pieces of information directly indicating certain treatment or protocols associated with the horse, for example a medical condition or recommendation relating to a horse, which can be used prior to information being received from a listed owner or veterinarian. For example, in locations with limited communications, such as during a fire evacuation, third parties may be unable to contact an owner or veterinarian, but could still receive information about treatment of the horse from the tag 100 itself. As examples only, horse information 208 could indicate a horse is affected by arthritis, back or dental issues, laminitis or other hoof issues, and/or gastrointestinal tract issues such as colic. This horse information 208 may help a temporary shelter or evacuation site, or facilities used during a horse show (for example with hundreds or thousands of horses in attendance) or for horse care, provide better or acceptable care for a horse, even if medical records are not fully available. As one example, the food provided at a facility could be tailored based on dental or dietary issues associated with one or more horses, based on the accessible horse information 208 included in tag 100.

In some cases, display 200 is folded or two-sided, with the additional information 212 on the second portion or backside of display 200. Similarly, second display 210 can include second additional information 214, which could include medical information, etc., or spillover medical or other information that did not fit in horse information 208, and second additional information 214 can be shown when second display 210 is unfolded or flipped over, for example, or when tag 100 is opened or unfolded. In embodiments, a tag 100 is connected to a horse and includes display 210, while a separate tag 100 is connected to a rider of the horse and includes display 200. A tag 100 system in accordance with embodiments of the invention can include two tags, e.g., tag 100, both containing information associated with the same rider-horse combination, for example the same horse name and owner. In some cases, both sides of tag 100 can include information on or more of the two tag faces. Embodiments include a watermark or other design (not shown) in the background of display 200 and/or second display 210, which can indicate the trustworthiness of the information, for example.

Turning to FIG. 3A, an illustrative embodiment of a saddle tag system 300 is shown, which can be an aspect of a tag 100 system. In this example, tag 100 is attached to a saddle 302, for example with strap 106 being buckled to form a closed loop that interacts with a receiver 304, in this case by being inserted through it and then buckled or closed. In some cases, a connector 306 can be used to secure the receiver 304 to the saddle 302. In embodiments, the connector 306 can be a pre-existing portion of a saddle 302 that is used by the receiver 304 (or the strap 106 directly, in some cases) to affix tag 100 to a saddle 302. Some examples exists where tag 100 is affixed to a connector 306 that is an extended portion or fixture of either a saddle 302 or a pad or other layer used underneath or otherwise used with a saddle 302.

In some embodiments, a saddle 302 including a tag 100 are associated with a particular rider and/or a particular horse, with tag 100 essentially permanently affixed to saddle 302 for long-term use by the rider, while in other embodiments tag 100 can be switched out from saddle 302 and interchanged with another tag 100, depending upon the horse and/or rider using the saddle 302. If a situation arises where a rider becomes separated from a horse, such as a rider's medical emergency, a saddle 302 including tag 100 could still be used to help locate the horse, identify the horse, and identify the rider, including rider information 204.

In FIG. 3B, an exemplary rider tag configuration 310 is shown in accordance with an embodiment of the present invention, which can be an aspect of a tag 100 system. A rider tag configuration 310 can include a tag 100 connected to an article 312 associated with a rider, for example in FIG. 3B article 312 is a belt, with tag 100 secured by including article 312 within a closed loop created by strap 106 of tag 100. In some cases, other aspects of a rider can be used for a rider tag configuration 310, for example a rider's belt or jacket, and tag 100 may be looped or secured around an article, e.g., article 312, or affixed using another type or fixture for connection, similar to connector 306 in FIG. 3A.

Turning now to FIG. 3C, an exemplary mane tag system 320, in accordance with an embodiment, is shown. A mane tag system 320 may be part of a tag 100 system or, as with other examples shown herein, may be used as a single tag 100. FIG. 3C illustrates an embodiment that includes a tag 100 affixed to a mane 322. A tag 100 could be attached or secured to a mane 322 in a variety of ways, such as clipping or an adhesive, or using a band or other method to connect tag 100 to mane 322. In an embodiment shown in FIG. 3C, tag 100 is affixed to a mane 322, for example to a mane extension 324 of mane 322. In some cases, tag 100 is buckled around a mane extension 324 of mane 322, or otherwise attached using elastic material around a mane extension 324 or another fixture. In the specific embodiment illustrated, strap 106 of tag 100 is affixed around a portion of mane extension 326, for example by encircling the mane extension 326, which is then included in the mane extension 324, in some cases securing tag 100 to the mane 322. For example, portion of mane extension 326 can be braided with or otherwise joined with the remainder of mane extension 324, as illustrated in FIG. 3C, which can provide an essentially permanent placement of tag 100, which is still readily visible and comprehendible by third parties. In some cases, portions of a tail can be braided or joined with other portions of a tail to provide placement of tag 100 in a tail, in a similar fashion as shown with respect to a mane in FIG. 3C, for example. The thickness of the portions of mane or tail can vary, and the length of a braid can also vary.

In some cases, mane extension 324 is previously prepared, such as braided and/or secured, such as by a band or other material or style, and tag 100 is then applied to the mane extension 324 as a mane tag system 320. FIGS. 3A and 3C are example of tag systems associated with a horse, which provides a semi-permanent solution to the issue of timely contacting and treatment related to horses. For example, when a tag 100 is secured to a horse as made possible by configurations of embodiments described here, it can remain in a horse's mane or other location for weeks or months, in some cases without any adjustments needed. Additionally, in embodiments, a tag 100 can be secured to other aspects of a horse, such as a tail, including in the same manner shown in FIG. 3C, with a portion of the horse hair woven or otherwise arranged to provide for securing strap 106 to a horse.

Turning to FIG. 3D, a tag 100 is shown secured to another aspect of an individual, such as to an item of clothing 332. An item of clothing 332 is a garment designed for equestrian purposes, in an embodiment, such as an inflatable vest. A tag 100 can be easily visible and understood to relate to identification or emergency information regarding a rider or a horse. In some cases, the tag 100 is designed to loop or surround a fastener portion 334 of an item of clothing 332, such as an inflatable vest associated with equestrian activities. In embodiments, an individual is more likely to wear the tag 100 when it is affixed to an item of clothing 332 associated with certain activities, such as a safety vest associated with horse-riding activities. In some cases, tag 100 is permanently or semi-permanently affixed to an item of clothing 332, such as by securing the tag 100 around or to a fastener portion 334 of a vest or another part. In this way, an individual is not required to remember to use the tag 100 each time. Additionally, a second individual may be likely to also wear the same item of clothing 332, for example by borrowing or using the safety equipment associated with a horse or horse riding. In that case, a temporary rider is more likely to have the tag 100 while wearing equipment, such as an inflatable vest, which can help provide emergency or safety services for the temporary rider and horse. One example of an inflatable vest is Hit Air® Equestrian vest.

A tag 100 system can comprise tag 100 according to one or more embodiments of the present invention, or more than one tag secured to more than location, for example on a saddle and to a mane, or used as back-ups, or secured to a rider and a horse, for example. In embodiments, information such as horse information 208 is automatically provided based on registration information at event or veterinarian, for example. In embodiments, a display such as second display 210 can be printed, including specific information for a horse and/or rider, onto a tag 100 or onto a material that will be inserted or affixed to a tag 100, for instance using information from a database, to provide a tag 100 for one or more horses and/or riders at an event or other location in near real-time. In some cases, an updated second display 210 can be printed or otherwise created, to be added to tag 100, which could be a blank or available tag 100, or an out-of-date tag 100 that requires updating, in which case an updated second display 210 that is printed can be applied over the out-of-date information on tag 100, such as by an adhesive, or using magnetic force, or by another manner for applying a second display 210 to tag 100.

It is possible, in embodiments, to include a radio frequency identification (RFID) tag or other mechanisms for conveying data or tracking remote activity or conditions. Some examples could include a code or other information or symbols that can be scanned or electronically read as part of display 200, second display 210, and/or graphic area 128, for example to confirm information or to retrieve additional information, and/or to automatically connect with an individual or entity associated with a horse, such as an owner or veterinarian. The present invention has been described in relation to particular embodiments, which are intended in all respects to be illustrative rather than restrictive. Further, the present invention is not limited to these embodiments, but variations and modifications may be made without departing from the scope of the present invention.

1. An identification system comprising:
a first tag portion having a substantially rectangular shape, a first edge, a second edge, and a third edge, the first tag portion including a first tag area and an aperture proximate the third edge;
a first strip of fluorescent material on a first edge of the first tag portion and a second strip of fluorescent material on a second edge of the first tag portion;
a first display of information associated with a horse on the first tag area;
a strap removably coupled to the first tag portion through the aperture, the strap having a buckle affixed to a first end, a keeper affixed proximate the buckle, a free end opposite the first end, and a plurality of buckling apertures between the first end and the free end; and
the buckle configured to removably couple with the free end of the strap at one of the plurality of buckling apertures such that the strap is configured to move from a buckled state to an unbuckled state and back to the buckled state, wherein the strap is configured to removably couple with a mane of the horse when in the buckled state,
wherein the free end of the strap is threaded through the keeper when the strap is in the buckled state.
a first tag portion in a substantially rectangular shape, including a first tag area;
a first strip of fluorescent material on a first edge of the first tag portion; and
a first display of information associated with a horse on the first tag area.

2-5. (canceled)

6. The system of claim 1, wherein the third edge of the first tag portion comprises two sloped edge portions.

7. (canceled)

8. The system of claim 1, wherein a first portion of the strap is configured to partially overlap a portion of a first element, wherein the first element is a mane.

9. The system of claim 1, wherein a second tag area includes a reflective graphic.

10. A tag system for use with a horse, comprising:
a tag comprising a front panel attached to a back panel to form a pocket, the pocket having a pocket opening at a side of the tag, strap apertures formed through each of the front panel and the back panel proximate the side of the tag at the pocket opening;
a plastic sleeve configured to be received within the pocket and provide a water-proof barrier to articles contained within the plastic sleeve;
an insert removably received within the plastic sleeve, the insert including rider information written on the insert and associated with a rider of the horse;
a strap configured to form a closed loop, the strap having a buckle at a first end and extending to a free end, the strap having a plurality of apertures between the free end and the buckle for forming closed loops of different sizes, the strap extending through the strap apertures of the front panel and the back panel to secure the insert within the pocket, wherein when the loop is closed the insert cannot be removed from the pocket; and
a medically-related indication on the front panel.

11. The system of claim 10, wherein the medically-related indication is reflective.

12. The system of claim 10, wherein the tag includes one or more edges with one or more fluorescent strips applied to each of the one or more edges.

13. The system of claim 10, wherein the insert includes information associated with the horse.

14. The system of claim 10, wherein the strap affixes the tag to a saddle.

15. The system of claim 10, wherein the strap affixes the tag to a mane.

16. The system of claim 15, wherein the strap is configured to affix the tag to a mane by forming a loop around a portion of the mane when the portion of the mane is woven.

17. A tag system for use with a horse comprising:
a horse having a mane;
a tag having a pocket containing a display of contact information the tag having a plurality of strips of fluorescent material affixed along a plurality of sides of the tag, and a reflective material affixed to a front face of the tag, the pocket having a pocket opening; and
a strap extending through the tag at the pocket opening to secure the insert within the pocket, the strap having a buckle affixed to a first end and a free end configured to detachably couple to the buckle, the strap having an unbuckled state where the free end is uncoupled with the buckle and may be threadably disengaged from the tag and a buckled state where the free end is detachably coupled to the buckle to form a closed-loop around a portion of the mane.

18. (canceled)

19. The tag system of claim 17, wherein the tag system is configured to be semi-permanently secured to the horse.

20. The tag system of claim 17, wherein the contact information comprises veterinary contact information.
